(19) United States
(12) Patent Application Publication
(10) Pub. No.: US 2015/0104676 A1
(43) Pub. Date: Apr. 16, 2015

(54) BATTERY FOR AUTOMOTIVE ELECTRICAL SYSTEM

(71) Applicant: SANYO Electric Co., Ltd., Osaka (JP)

(72) Inventors: Wataru Okada, Hyogo (JP); Masao Saito, Hyogo (JP); Fumio Yasutomi, Hyogo (JP)

(21) Appl. No.: 14/399,844

(22) PCT Filed: Jun. 4, 2013
(86) PCT No.: PCT/JP2013/065420

§ 371 Date: Nov. 7, 2014

(30) Foreign Application Priority Data
Jun. 11, 2012 (JP) 2012-132112

(51) Int. Cl. H01M 2/20; H01M 10/42; H01M 2/30; H01M 10/12

(52) U.S. Cl. CPC H01M 2/206; H01M 10/12; H01M 10/425; H01M 2/305; H01M 2220/20
USPC 429/7; 429/9

(57) ABSTRACT

A battery for automotive electrical system comprises a lead battery having an outer shape of a rectangular box and having length longer than the width, and a sub-battery connected in parallel to the lead battery. A first main terminal as a positive electrode terminal and a second terminal as a negative electrode terminal are disposed at both ends adjacent to a long side on an upper surface. The first main terminal as an output terminal of the lead battery is connected to a vehicle lead line, and the second main terminal is connected to the sub-battery. The sub-battery has a structure in which plural cells are stored in an outer case, and the outer case is disposed outside an end portion in the lengthwise direction of the lead battery and adjacent to the second main terminal of the lead battery, and the lead battery and the sub-battery are coupled.

### CROSS-REFERENCE TO RELATED APPLICATIONS

The present application is a national phase application of international application PCT/JP2013/065420 filed on Jun. 4, 2013, and claims the benefit of foreign priority of Japanese patent application 2012-132112 filed on Jun. 11, 2012, the contents both of which are incorporated herein by reference.

### TECHNICAL FIELD

The present invention is related to a battery for automotive electrical system which is effectively charged by regenerative energy from regenerative braking, especially a battery for automotive electrical system which is incorporated by a vehicle in place of a conventional lead battery.

### BACKGROUND ART

A prior art vehicle incorporates a lead battery as a battery for automotive electrical system. The lead battery is charged by a generator, and provided power to electrical equipment, or a starter motor. The lead battery has a demerit in which the durability against frequent charging and discharging of large currents is low and the life is short. Therefore when the lead battery is used in a vehicle having the idle stop function, or is quickly charged by regenerative energy from regenerative braking at the time of braking in the vehicle, the life of the lead battery is remarkably short by frequent charge or discharge of large currents. In order to prevent this demerit, a battery for automotive electrical system in which a sub-battery of a lithium ion battery or the like is connected to a lead battery in parallel is developed (see patent literature 1).

### CITATION LIST

### Patent Literature

Patent Literature 1:
Japanese Laid-Open Patent Publication No. 2011-15516

### SUMMARY OF THE INVENTION

A battery for automotive electrical system of patent literature 1 is a lead battery and a lithium ion battery connected in parallel which are electrically connected to an alternator of a vehicle. Further in this battery for automotive electrical system, by setting internal resistances or open circuit voltages of the lead battery and the lithium ion battery in a predetermined condition, the lead battery and the lithium ion battery are connected in parallel without a DC/DC converter. Therefore it reduces costs.

Here in order to set the lead battery at a predetermined position, the vehicle fixes a mounting stand to mount the lead battery on, and the lead battery is mounted on the mounting stand. And a holding metal part is disposed on the upper surface of the lead batter, and this holding metal part is coupled to the mounting stand, so the lead battery is fixed. The mounting stand has a shape on which the lead battery of a regulated size is mounted. The lead battery is disposed in an engine room, and the lithium ion battery is positioned apart from the lead battery, since the engine and various equipment are disposed in the engine room. It is remarkably troublesome or taking time to connect the lithium ion battery to the lead battery in parallel. Especially in the vehicle in which the lithium ion battery is disposed in the engine room, it is necessary to dispose the lithium ion battery in a position where a damage of the lithium ion by heat is small. Therefore it makes disposing of the lithium ion more difficult. The damage by heat is prevented by disposing the lithium ion battery in a trunk room or a car inside space. However when the lithium ion battery is disposed in the car inside space, it is remarkably troublesome or taking time to connect the lithium ion battery to the lead battery in the engine room by electric lines, since it is necessary that long electric lines penetrate a separating wall which separates the engine room and the car inside space. In addition, as remarkably large current flows through these electric lines, lead lines which are thick, low resistance value are used. So it is remarkably troublesome or taking time to carry out wiring. Furthermore in electric lines connecting between the lithium ion battery and the lead battery, voltage drop and power loss by large current are big, so those are demerits.

The present disclosure is developed for the purpose of solving such drawbacks. One non-limiting and explanatory embodiment provides a battery for automotive electrical system in which a lead battery is connected to a sub-battery in parallel, and the sub-battery is set at an optimum position simply and easily in the same way as a lead battery by itself while decreasing power loss by electric lines.

A battery for automotive electrical system of the present disclosure comprises a lead battery having an outer shape of a rectangular box, and having the length (L) thereof which is longer than the width (W) thereof, a sub-battery being connected in parallel to the lead battery. A first main terminal as a positive electrode terminal and a second main terminal as a negative electrode terminal are disposed at both ends adjacent to a long side on an upper surface of the rectangular box. The first main terminal as an output terminal is connected to a lead wire for a vehicle, and the second main terminal is connected to the sub-battery. The sub-battery has a structure in which plural cells are stored in an outer case. The outer case is disposed outside an end portion in the lengthwise direction of the lead battery and adjacent to the second main terminal of the lead battery, and the lead battery and the sub-battery are coupled.

In the above battery for automotive electrical system, while the lead battery is connected to the sub-battery in parallel, the sub-battery is set at an optimum position simply and easily in the same way as a lead battery by itself, decreasing power loss by electric lines connecting between the lead battery and sub-battery. That is a reason why the outer case is disposed outside an end portion in the lengthwise direction of the lead battery and adjacent to the second main terminal of the lead battery, and the lead battery and the sub-battery are coupled in an integral structure. The above battery for automotive electrical system having the sub-battery in the integral structure is the same outer shape as the lead battery of high capacity. Therefore in place of the lead battery, it can be mounted on a mounting stand of the lead battery. In addition, as the sub-battery is disposed outside the end portion of the lead battery, a bus bar connecting the sub-battery and the lead battery in parallel can be shortened, and power loss can be decreased by low resistance of the bus bar.

In the battery for automotive electrical system of the present disclosure, in the sub-battery a second sub-terminal is connected to the second main terminal of the lead battery, and is disposed at an end to the second main terminal of the lead battery on an upper surface of the outer case.

In the above battery for automotive electrical system, the second sub-terminal of the sub-battery and the second main terminal of the lead battery are close, and a bus bar having low resistance can be connected, and power loss can be decreased by low resistance of the bus bar.

In the battery for automotive electrical system of the present disclosure, in the sub-battery a first sub-terminal and the second sub-terminal B are disposed at both ends in the width direction on an upper surface of the outer case, and the second sub-terminal is connected to the second main terminal of the lead battery.

In the above battery for automotive electrical system, as the first sub-terminal and the second sub-terminal of the sub-battery are disposed in spaced relationship, while it prevents demerits of short circuit between the positive and negative sub-terminals or the like, the second sub-terminal of the sub-battery is connected to the second main terminal of the lead battery by a short bus bar, and power loss of the bus bar can be decreased.

In the battery for automotive electrical system of the present disclosure, the first main terminal of the lead battery and the first sub-terminal of the sub-battery are connected by a first bus bar disposed on an upper surface of the lead battery and an upper surface of the first bus bar is insulated.

In the above battery for automotive electrical system, as the bus bar which connects the first main terminal of the lead battery and the first sub-terminal of the sub-battery is insulated, voltage bus bars are not exposed on the upper face, and it is safely used, being mounted on a mounting stand of the lead battery in the same way as the conventional lead battery.

In the battery for automotive electrical system of the present disclosure, a width size (w) of the outer case of the sub-battery does not project from the width of the lead battery.

In the above battery for automotive electrical system, as the width size (w) of the outer case of the sub-battery does not project from the width of the lead battery, it can be mounted on the mounting stand on which the lead battery is mounted in place of the lead battery without a sub-battery.

In the battery for automotive electrical system of the present disclosure, a height size (h) of the outer case of the sub-battery does not project from the height of the lead battery.

In the above battery for automotive electrical system, while the sub-battery is coupled to the lead battery, the sub-battery does not project from the height of the lead battery, it can be conveniently disposed in the engine room which limits the height in place of the lead battery.

In the battery for automotive electrical system of the present disclosure, the width size (w) of the outer case of the sub-battery is approximately the same as the width size (W) of the lead battery.

In the above battery for automotive electrical system, while the sub-battery is connected to the lead battery in parallel, it has the same width as the outer shape in the lead battery having high capacity by itself. Here, a table 1 shows the outline standard of the lead battery for Europe, a table 2 shows the outline standard of the lead battery for Japan (H: height W: width L: length).

TABLE 1

| | H[mm] | W[mm] | L[mm] |
|---|---|---|---|
| H8 | 190 | 175 | 353 |
| H7 | 190 | 175 | 315 |
| H6 | 190 | 175 | 278 |
| H5 | 190 | 175 | 242 |

TABLE 2

| | H[mm] | W[mm] | L[mm] |
|---|---|---|---|
| D31 | 204 | 173 | 305 |
| D26 | 204 | 173 | 260 |
| D23 | 204 | 173 | 232 |

As shown in these tables, the lead batteries have different sizes only in lengths by different capacities, and the same size in width and height. In the battery for automotive electrical system, the sub-battery and the lead battery are connected in parallel, and the width (w) of the sub-battery is the same as the width (W) of the lead battery. Therefore, the battery for automotive electrical system has the same size as the lead battery of higher capacity, it can be mounted on the mounting stand of the lead battery.

In the battery for automotive electrical system of the present disclosure, the height size (h) of the outer case of the sub-battery is approximately the same as the height size (H) of the lead battery.

In the above battery for automotive electrical system, as the height size of the sub-battery is approximately the same as the height size of the lead battery, it can be mounted on the mounting stand in place of the lead battery, and it can be conveniently used in the narrow engine room or the like which limits the height in place of the lead battery.

In the battery for automotive electrical system of the present disclosure, the sub-battery is any one of a nickel hydride battery, a nickel cadmium battery, or a non-aqueous electrolyte battery.

In the above battery for automotive electrical system, the sub-battery is a nickel hydride battery. Compared with a battery for automotive electrical system having only the lead battery, it can be effectively charged by regenerative energy from regenerative braking, and fuel efficiency of the vehicle is remarkably improved. FIG. 1 shows charging currents of the nickel hydride battery and the lead battery charged by regenerative energy. As apparent from this figure, when voltage of batteries is increased by regenerative braking, charging current of the nickel hydride battery shown by line A is bigger than charging current of the lead battery shown by line B. For example, in batteries charged by a generator driven by regenerative braking, when the charging voltage increases at about 15 V, the lead battery is charged at only about 25 A, the nickel hydride battery is charged at about 170 A. Namely, charging current of the nickel hydride battery is about 7 times as much as that of the lead battery. From this, when the lead battery is charged by regenerative braking, regenerative energy is not efficiently recovered by small charging current. In contrast, regenerative energy is efficiently recovered by the nickel hydride battery.

Here, regenerative energy is generated by the generator driven by kinetic energy of the vehicle at the time of braking the vehicle. As regenerative braking generates large kinetic energy in a short time, the time length of generation is short, but generating current is very large. For example, by one time of the regenerative braking when the driving vehicle stops, electric energy of 20 Wh to 50 Wh is generated. When one regenerative braking is 20 Wh and the time until vehicle's stopping by the regenerative braking is 36 seconds, generating power is 2000 W, charging current is about 170 A. Actually, as the time until vehicle's stopping by regenerative braking is shorter than 36 seconds, charging current by regenerative braking becomes larger. In this manner, in the battery for automotive electrical system in which large regenerative energy is recovered, by the nickel hydride battery having large charging current connected to the lead battery in parallel, regenerative energy can be efficiently stored in the nickel hydride battery. The battery for automotive electrical system which is efficiently charged by regenerative braking consumes a little fuel for charging the battery, fuel efficiency of the vehicle is remarkably improved. Conversely, at the time of large discharging current, for example, starting engine or using high load, the burden of the lead battery is reduced, and the life of the lead battery is kept.

Here, normally, the optimum using voltage of the lead battery is predetermined, it is desirable to be used at the range of 12 V to 15 V. In the case of using the nickel hydride battery as the sub-battery, the voltage of the nickel hydride battery is 1.35 V as the open circuit voltage at SOC 50%, series connected 10 pieces of the nickel hydride battery is 13.5 V. Therefore, in the above battery for automotive electrical system using the nickel hydride battery as the sub-battery, charging and discharging (for example, the range of SOC 20% to 80%) are carried out within the range of 12 V to 15 V which is desirable using voltage of the lead battery. Accordingly, at the time of using the nickel hydride battery, a DC/DC converter, or the structure of the above patent literature 1 is unnecessary, the battery for automotive electrical system is a simple structure.

Further, as the nickel cadmium battery has the charging and discharging characteristics similar to the nickel hydride battery, in the battery for automotive electrical system having the nickel cadmium battery as the sub-battery connected to the lead battery in parallel, regenerative energy is efficiently recovered. In addition, in the battery for automotive electrical system having the non-aqueous electrolyte secondary battery as the sub-battery, as in the non-aqueous electrolyte secondary battery its capacity to volume and weight is large, compared with the lead battery, charging and discharging capacity can be enlarged while it is downsized.

The battery for automotive electrical system of the present disclosure comprises an output switch 3 being connected in series to the sub-battery, and a control circuit carrying out ON/OFF control of the output switch, and the control circuit detects any one of a remaining capacity or a voltage of the sub-battery, and controls the output switch.

In the above battery for automotive electrical system, the sub-battery is effectively charged and discharged, degradation is suppressed, and the life is made longer. That is a reason why by controlling the output switch, over charge and over discharge are prevented.

In the battery for automotive electrical system of the present disclosure, the lead battery and the sub-battery are integrally connected by connecting part, and the main terminal of the lead battery and the sub-terminal of the sub-battery are connected by bus bar made of metal, and the metal bus bar is used as the connecting part.

In the above battery for automotive electrical system, by the bus bar the sub-battery and the lead battery are connected, the bus bar is also used as the connecting part by which the sub-battery and the lead battery are connected in integral structure.

In the battery for automotive electrical system of the present disclosure, the second main terminal of the lead battery and the second sub-terminal of the sub-battery are connected by the bus bar, and the bus bar is used as the connecting part.

In the battery for automotive electrical system of the present disclosure, the first main terminal of the lead battery and the first sub-terminal of the sub-battery are connected by the bus bar, and the bus bar is used as the connecting part.

### BRIEF DESCRIPTION OF DRAWINGS

FIG. 1 is a graph showing charging current-voltage characteristics of a nickel hydride battery and a lead battery charged by a regenerative power.

FIG. 2 is a perspective view of a battery for automotive electrical system according to an embodiment of the present disclosure.

FIG. 3 is a schematic plan view of the battery for automotive electrical system of FIG. 2.

FIG. 4 is a schematic plan view of a battery for automotive electrical system of another structure of a lead battery.

FIG. 5 is a schematic plan view of a battery for automotive electrical system of another structure of a lead battery.

FIG. 6 is a schematic plan view of a connecting part according to one example.

FIG. 7 is an electrical circuit of a battery for automotive electrical system according to an embodiment of the present disclosure.

FIG. 8 is an electrical circuit of a battery for automotive electrical system according to another embodiment of the present disclosure.

FIG. 9 is an electrical circuit of a battery for automotive electrical system according to another embodiment of the present disclosure.

FIG. 10 is an electrical circuit of a battery for automotive electrical system according to another embodiment of the present disclosure.

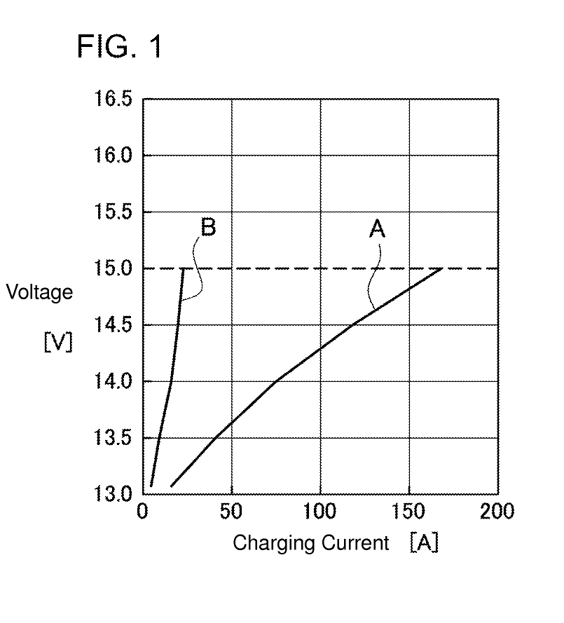

### DESCRIPTION OF EMBODIMENTS

Hereinafter, the embodiment of the present invention will be described referring to drawings. However, the following embodiments illustrate a battery for automotive electrical system which is aimed at embodying the technological concept of the present invention, and the present invention is not limited to the battery for automotive electrical system described below. However, the members illustrated in Claims are not limited to the members in the embodiments.

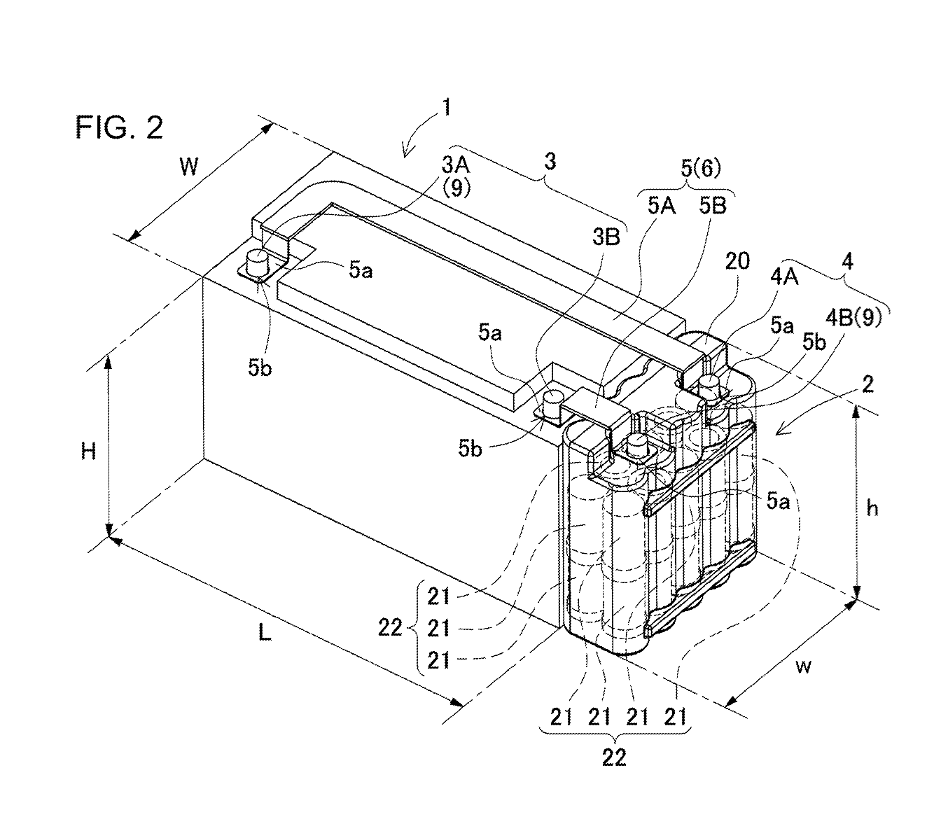

The battery for automotive electrical system shown in a perspective view of FIG. 2 comprises a lead battery 1 having an outer shape of a rectangular box, and a sub-battery 2 which is connected in parallel with this lead battery. The lead battery 1 and the sub-battery 2 are integrally connected.

### [Lead Battery 1]

The lead battery 1 is the rectangular box shape having the length (L) thereof which is longer the width (W) thereof. In FIG. 2, the lead battery 1 disposes positive and negative main terminals 3 at both ends adjacent to a long side on an upper surface of the rectangular box. The main terminals 3 each have a cylindrical shape, and the taper to slightly make it thin toward the top. In FIG. 2, a first main terminal 3A which is disposed at the left side of the upper surface of the lead battery 1 is an output terminal 9 of the battery for automotive electrical system connected to a vehicle lead line. A second main terminal 3B which is disposed at the right side is connected to a sub-terminal 4 of the sub-battery 2.

### [Sub-Battery 2]

In the sub-battery 2 plural cells 21 are stored in an outer case 20. The outer case 20 is made of an insulating material of a plastic or the like, molded in a box shape. The outer case 20 has positive and negative sub-terminals 4 projecting from the upper surface thereof. The positive and negative sub-terminals 4 are disposed at both ends in the width direction on the upper surface of the outer case. The sub-terminals 4 are the same shape as the main terminals 3 of the lead battery 1. Namely the sub-terminals 4 of the sub-battery 2 each have a cylindrical shape, and the taper to slightly make it thin toward the top. The positive sub-terminal 4 of the sub-battery 2 has the same shape as the positive main terminal 3 of the lead battery 1, the negative sub-terminal 4 of the sub-battery 2 has the same shape as the negative main terminal 3 of the lead battery 1. In the sub-battery 2 of this structure, the sub-terminal 4 of the sub-battery 2 is used as the output terminal 9 of the battery for automotive electrical system, namely a terminal connected to a vehicle lead line.

In the sub-battery 2, the outer case 20 is disposed outside an end portion in the lengthwise direction of the lead battery 1 and outside the end portion adjacent to the second main terminal 3B of the lead battery 1, namely outside the low right portion of the lead battery 1 in FIG. 2, and the lead battery 1 and the sub-battery 2 are integrally coupled. The lead battery 1 and the sub-battery 2 are integrally coupled by bus-bars 5, or by a bind-bar (not shown in figures) binging its periphery. The sub-battery 2 is integrally coupled to the lead battery 1, and detachably integrally coupled. In this battery for automotive electrical system, when the lead battery 1 having shorter life than that of the sub-battery 2 is degraded, the integral structure is disassembled. And as the lead battery 1 can be replaced, the sub-battery 2 is effectively used.

### [Outer Case 20 of Sub-Battery 2]

In the battery for automotive electrical system in FIG. 2, the width size (w) of the outer case 20 of the sub-battery 2 is approximately the same as the width size (W) of the lead battery 1, and the height size (h) of the outer case 20 of the sub-battery 2 is approximately the same as the height size (H) of the lead battery 1. The width size (w) and the height size (h) of the sub-battery 2 are approximately the same as those of the lead battery 1. This means that it can be mounted on a mounting stand in the same way as the lead battery 1 having a high capacity in a state of integrally coupling the sub-battery 2 to the lead battery 1, for example, it has a size within plus or minus 10% of the size of the lead battery 1.

This battery for automotive electrical system in which the sub-battery 2 is integrally coupled to the lead battery 1 is mounted in the vehicle in place of a lead battery having a high capacity, namely a longer lead battery only in length as the same outer shape as the lead battery 1. Here also in the outer case 20 of the sub-battery 2, the width size (w) does not project from the width of the lead battery 1, namely the width size can be narrower than the width of the lead battery 1, in addition, the height size (h) does not project in the vertical direction of the lead battery 1, namely the height size (h) can be lower than the height size (H) of the lead battery 1.

### [Bus Bar 5]

In the sub-battery 2 a second sub-terminal 4B is connected to the second main terminal 3B of the lead battery 1, and is disposed at an end (the lower left side of the outer case 20 in FIG. 2) to the second main terminal 3B of the lead battery 1 on an upper surface of the outer case 20. The second sub-terminal 4B of the sub-battery 2 is disposed adjacent to the second main terminal 3B of the lead battery 1, is connected by the second bus bar 5B.

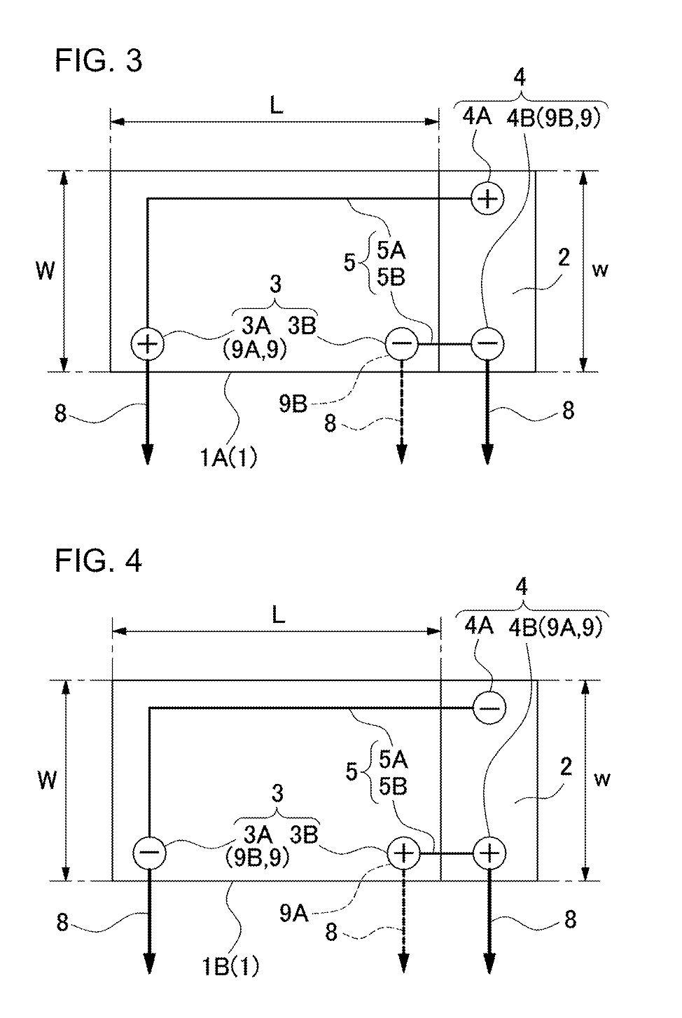

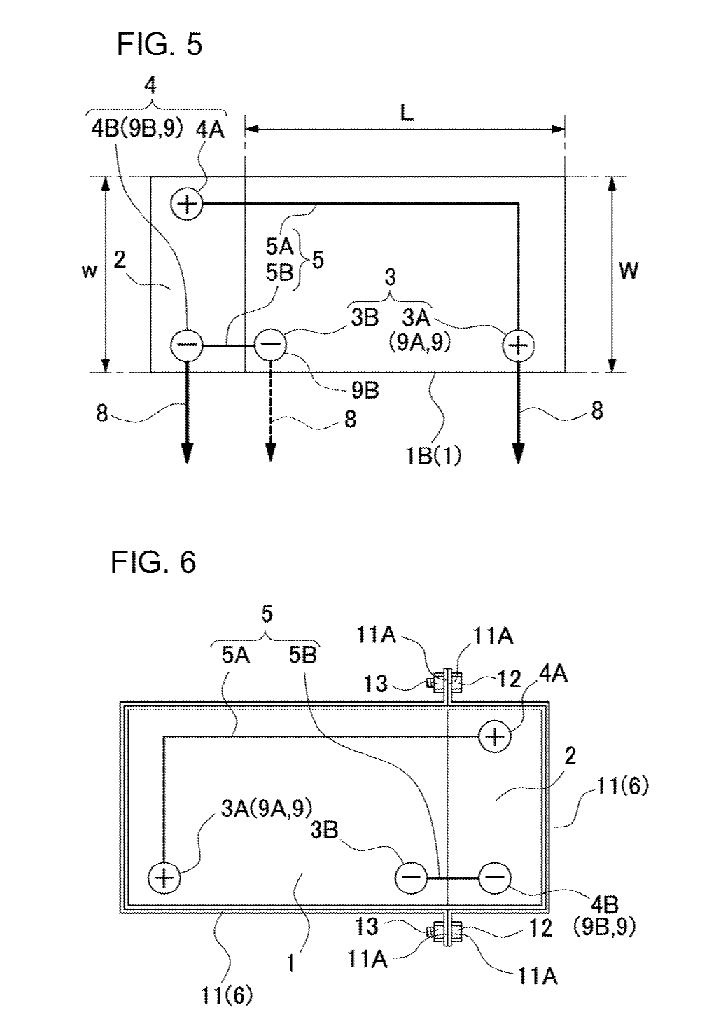

The lead battery 1 which is incorporated in the vehicle, as shown in FIG. 3 to FIG. 5, has 2 types (the last letter of model name is R or L) which dispose the positive and negative main terminals 3 in opposite positions. The sub-battery 2, as shown in FIG. 3 to FIG. 5, is integrally coupled to the lead battery 1A or 1B, and the sub-battery 2 is used while the sub-battery 2 is incorporated in the same way as 2 types of the lead battery 1A, 1B. Here in the battery for automotive electrical system shown in FIG. 3 and FIG. 4, the sub-battery 2 is coupled outside an end portion in the lengthwise direction of the lead battery 1, and in the right side of the battery in the figures. Therefore in the battery for automotive electrical system, at both ends of the upper surface of the lead battery 1, the main terminal 3 positioned in the left side in the figures is the first main terminal 3A, and the main terminal 3 positioned in the right side in the figures is the second main terminal 3B. Here in the battery for automotive electrical system shown in FIG. 5, the sub-battery 2 is coupled outside an end portion in the lengthwise direction of the lead battery 1, and in the left side of the battery in the figure. Therefore in the battery for automotive electrical system shown in FIG. 5, at both ends of the upper surface of the lead battery 1, the main terminal 3 positioned in the right side in the figure is the first main terminal 3A, and the main terminal 3 positioned in the left side in the figure is the second main terminal 3B.

In the battery for automotive electrical system of FIG. 3 to FIG. 5, one output terminal 9 is the first main terminal 3A, the other output terminal 9 is the second sub-terminal 4B. The output terminals 9 are connected to lead wires 8 for a vehicle. In the battery for automotive electrical system, the positive and negative output terminals 9 are disposed at both ends of the upper surface in the same way as the main terminal 3 of the lead battery 1. Therefore in place of the lead battery 1, the lead wires 8 are connected to the battery for automotive electrical system in the same way.

In the battery for automotive electrical system of FIG. 3 and FIG. 5, the first main terminal 3A of the lead battery 1 is the positive output terminal 9A, the second sub-terminal 4B of the sub-battery 2 is the negative output terminal 9B. In the battery for automotive electrical system of FIG. 4, the first main terminal 3A of the lead battery 1 is the negative output terminal 9B, the second sub-terminal 4B of the sub-battery 2 is the positive output terminal 9A.

In the battery for automotive electrical system of FIG. 3 to FIG. 5, the positive and negative output terminal 9 can also be the positive and negative main terminals 3 as shown by the chain line. In the battery for automotive electrical system of FIG. 3 or FIG. 5, the first main terminal 3A of the lead battery 1 is the positive output terminal 9A, as shown by the chain line in the figures, the second main terminal 3B of the lead battery 1 is the negative output terminal 9A. In the battery for automotive electrical system of FIG. 4, the first main terminal 3A of the lead battery 1 is the positive output terminal 9B, as shown by the chain line in the figure, the second main terminal 3B of the lead terminal 1 is the positive output terminal 9A.

As shown by the solid line or the chain line in FIG. 3 to FIG. 5, one output terminal 9 is the second sub-terminal 4B of the sub-battery 2 or the second main terminal 3B of the lead battery 1 in the battery for automotive electrical system. In this battery for automotive electrical system the lead wires 8 for a vehicle are connected in a preferable state. That is a reason why position of one output terminal 9 can be switched to the second sub-terminal 4B of the sub-battery 2 or the second main terminal 3B of the lead battery 1, and can be connected to it.

In order to decrease power loss in the vehicle lead wire connected to the output terminal in the battery for automotive electrical system, the vehicle lead wire is made as short as possible. Accordingly it happens that connection of the output terminal 9 is impossible when position of the output terminal 9 of the batter for automotive electrical system is shifted. The batter for automotive electrical system in which the output terminal 9 is positioned at the same position as the lead battery 1 can be used in place of the lead battery 1. Further in the batter for automotive electrical system in which the output terminal 9 is positioned at the two positions, the output terminal 9 at the preferable position can be connected to the lead wire

The positive and negative sub-terminals 4 are disposed at both of the end portions in the width direction on the upper surface of the outer case 20 as shown in FIG. 3 and FIG. 4, and the lead batteries 1A, 1B in which the positive and negative main terminals 3 are located in the opposite sides, and the sub-battery 2 is integrally coupled to 2 types of the lead batteries 1A, 1B while postures of the sub-batter 2 coupled to the lead battery 1 are turned over by 180 degree within the horizontal plane. Additionally as shown in FIG. 3 and FIG. 5, the connecting position at which the sub-battery 2 is connected is switched at each end in the lengthwise direction of the lead battery 1, namely the sub-battery 2 is integrally coupled to 2 types of the lead batteries 1A, 1B while the sub-batter 2 is coupled to the lead battery 1 at the right and left inverted connecting positions in the figures.

The battery for automotive electrical system shown in FIG. 2 to FIG. 5, the first sub-terminal 4A and the first main terminal 3A are connected by a first bus bar 5A, the second sub-terminal 4B and the second main terminal 3B are connected by a second bus bar 5B. The sub-terminal 4A and the first main terminal 3A are disposed in the diagonal position on the upper surface of the battery for automotive electrical system, the second sub-terminal 4B and the second main terminal 3B are disposed adjacent to each other.

The first bus bar 5A shown in FIG. 2 is a metal plate having a L-shape in the whole shape, and has connecting portions 5a in which both end portions are bent step-wise downward, the connecting portions 5a are connected to the first sub-terminal 4A and the first main terminal 3A. Further the first bus bar 5A is disposed on the upper surfaces of the lead battery 1 and the sub-battery 2, an upper surface thereof except both ends is insulated. Not only the upper surface but also the whole periphery of the first bus bar 5A can be insulated. Insulating material is coated on the surface, or an insulating film is glued to the surface, or an insulating sheet or an insulating plate is stuck to the surface.

The second bus bar 5B shown in FIG. 2 is a metal strip plate shorter than the first bus bar 5A, and has connecting portions 5a in which both end portions are bent step-wise downward, the connecting portions 5a are connected to the second main terminal 3B and the second sub-terminal 4B.

Here in the above embodiment, the first bus bar 5A or the second bus bar 5B is made of the comparatively strong metal plate, but can also be a flexible bus bar having flexibility. As the flexible bus bar, a staked plate in which several sheets of thin metal plates of 0.1 to 0.2 millimeter are staked, or a metal line material, for example, a wire, a material having wires woven in a reticulate state, or the like are available. By using such a flexible bus bar, even though terminal positions are a little shifted by tolerance, connecting can be easily carried out. Further even though stress which shifts terminal positions of the lead battery and the sub-battery by a vibration of the vehicle or the like occurs, the flexible bus bar absorbs this stress, it effectively prevents damage or an occurrence of contact failure in terminal connecting portions.

### [Connecting Part 6]

The battery for automotive electrical system shown in FIG. 2 has through holes 5b at the connecting portions 5a of the first bus bar 5A and the second bus bar 5B, the main terminal 3 and the sub-terminal 4 penetrate those through holes 5b, the first bus bar 5A and the second bus bar 5B are fixed to the main terminal 3 and the sub-terminal 4. The connecting portions 5a of both ends in the first bus bar 5A and the second bus bar 5B are fixed to the main terminal 3 and the sub-terminal 4, the lead battery 1 and the sub-battery 2 are coupled by the first bus bar 5A and the second bus bar 5B. Therefore the first bus bar 5A and the second bus bar 5B are used both as a bus bar and a connecting part 6. Especially the battery for automotive electrical system can strongly couple the lead battery 1 and the sub-battery 2 at the upper portion by the connecting portions of both ends in the bus bar 5 being fixed to the main terminal 3 of the lead battery 1 and the sub-terminal 4 of the sub-battery 2, using the bus bar 5 both as the connecting part 6 and the bus bar. In the battery for automotive electrical system in which the top portions are coupled using the bus bar 5 both as the connecting part 6 and the bus bar, as shown in a schematic plan view of FIG. 6, a bind bar 11 as the connecting part 6 surrounding the periphery of the lead battery 1 and the sub-battery 2 can integrally couple the lead battery 1 and the sub-battery 2 strongly by binding of the bind bar 11. The bind bar 11 of FIG. 6 has opposite boards 11A which are made in parallel each other by both ends thereof being bent outside, locking screws 12 are inserted in through holes of the opposite boards 11A, and the locking screws 12 are fixed with nuts 13 by screwing. In the connecting part 6 the nuts 13 of the bind bar 11 are unscrewed, the connecting portions 5a of the first bus bar 5A and the second bus bar 5B are detached from the main terminal 3 and the sub-terminal 4, the lead battery 1 and the sub-battery 2 can be disassembled. Namely the lead battery 1 and the sub-battery 2 are detachably coupled as an integral structure.

### [Storage Structure of Cell 21]

The sub-battery 2 of FIG. 2 stores the plural cells 21 in the outer case 20. The cell 21 is a nickel hydride battery. But all secondary batteries which has charging-discharging characteristics more excellent than that of the lead battery, for example, a non-aqueous electrolyte secondary cell of a lithium ion battery or a lithium polymer battery, a nickel cadmium battery, or the like can be used as the cell. As the nickel hydride battery or the nickel cadmium battery has the rated voltage of 1.2 V, 10 pieces of the cells 21 are connected in series, and stored in the outer case 20. As the non-aqueous electrolyte secondary cell has the high rated voltage, for example, 3 or 4 pieces of the cells can be connected in series, its voltage is equal to the rated voltage of the lead battery 1.

In the sub-battery 2 of FIG. 2, the cell 21 is a cylindrical battery. In the sub-battery 2, 10 pieces of the cells 21 in a vertical posture in the same plane are disposed, those constitute a battery pack 22. In one unit of the battery pack 22, 5 rows in a upper step, and 5 rows in a lower step are disposed. Both ends of the upper and lower cells 21 are connected in series, further the adjacent cells 21 are connected in series, 10 pieces of the cell 21 are connected in series. In the sub-battery 2 of FIG. 2, two unit of the battery packs 22 are stacked in the horizontal direction, further the stacked battery packs 22 are connected in parallel, it is stored in the outer case 20. As shown in FIG. 2, the sub-battery 2 in which a plural of the battery packs 22 are disposed in a stacked state and are connected in parallel can increase its current capacity by increasing the number of the battery packs 22 which are stacked and connected in parallel. For example, two of the battery packs 22 which have a current capacity of 5 Ah per one unit are stacked, a current capacity of the sub-battery 2 is 10 Ah, and this current capacity is two times that of one unit.

The outer case 20 of FIG. 2 has a peripheral surface of a waveform shape so as to correspond to the periphery of the stored cylindrical battery. The outer case 20 of this shape enables to enhance contacting the stored cylindrical battery. In addition, compared with a case of the rectangular box, a surface area of the outer case is increased. Therefore cooling capability of the outer case 20 can be enhanced. The battery for automotive electrical system is often disposed in an engine room of a vehicle. The temperature inside the engine room tends to be high by heat generation of the engine. In the above structure, the outer case 20 is cooled by the outside air which flows in the engine room, and then the cylindrical batteries stored in the outer case 20 can be effectively cooled. Further as the cylindrical batteries are held in the predetermined position, being contacted to the inside of the outer case 20, stability against vibration or the like during driving can be enhanced.

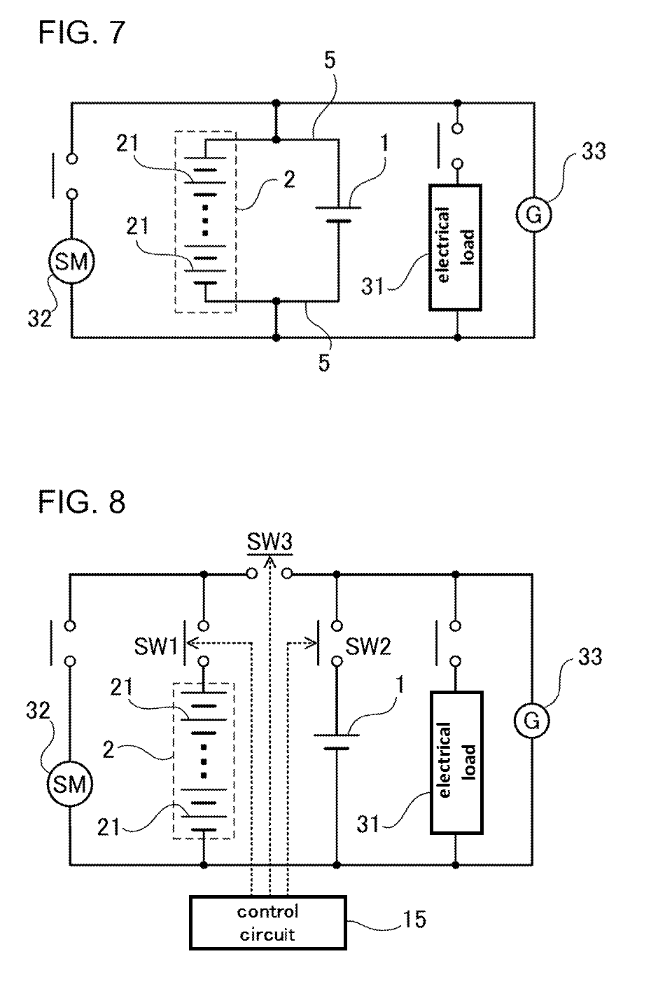

Electrical circuits of the batteries for automotive electrical system are shown in FIG. 7 to FIG. 10.

In the battery for automotive electrical system of FIG. 7, by the bus bar 5, the lead battery 1 and the sub-battery 2 are always connected in parallel.

In the battery for automotive electrical system of FIG. 8, a first output switch SW1 is connected to the output side of the sub-battery 2, a second output switch SW2 is connected to the output side of the lead battery 1, further a parallel switch SW3 connects the sub-battery 2 and the lead battery 1 in parallel, a control circuit 15 carries out ON/OFF control of the switches SW1, SW2, SW3. This battery for automotive electrical system turns the switches SW1, SW2, SW3 ON/OFF by the control circuit 15 in the following way

(1) A state of discharging to an electrical load 31 by a low rate current

In this state, SW1 and SW3 are OFF, SW2 is ON, and power is supplied to the electrical load 31 from the lead battery 1.

In this state, SW1, SW2, and SW3 are ON, and power can be supplied to the electrical load 31 from both the lead battery 1 and the sub-battery 2.

(2) A state of discharging to an electrical load 31 by a high rate current

In this state, SW1, SW2, and SW3 are ON, and power is supplied to the electrical load 31 from both the lead battery 1 and the sub-battery 2.

(3) A state of momentarily discharging by a high rate current at the time of starting an engine by a starter motor 32

In this state, SW2 and SW3 are OFF, SW1 is ON, and power is supplied to the starter motor 32 from the sub-battery 2.

In this state, SW1, SW2, and SW3 are ON, and power can be supplied to the starter motor 32 from both the lead battery 1 and the sub-battery 2. In addition, SW1 is OFF, SW2 and SW3 are ON, and power is supplied to the starter motor 32 only from the lead battery 1.

(4) A state of starting the starter motor 32 while power is supplied to the electrical load 31

In this state, SW3 are OFF, SW1 and SW3 are ON, and power is supplied to the starter motor 32 from the sub-battery 2, and power is supplied to the electrical load 31 from the lead battery 1.

Also in this state, SW1, SW2, and SW3 are ON, and power is supplied to both the starter motor 32 and the electrical load 31 from both the lead battery 1 and the sub-battery 2.

(5) A state of charging by regenerative energy from regenerative braking

In this state, SW2 is OFF, SW1 and SW3 are ON, and the sub-battery 2 is charged by regenerative energy. As power is also supplied to the electrical load 31, a switch of the electrical load 31 is ON.

In this state, SW1, SW2, and SW3 are ON, and both the lead battery 1 and the sub-battery 2 are charged by regenerative energy. Especially, when the remaining capacity of the sub-battery 2 increases near the maximum remaining capacity, both the lead battery 1 and the sub-battery 2 are charged by regenerative energy, it prevents over charge of the sub-battery 2. Further, when the remaining capacity of the sub-battery 2 reaches the maximum remaining capacity, SW1 is turned OFF, only the lead battery 1 is charged by regenerative energy.

(6) A state of charging by a low rate current at the time of decrease of the capacity of the lead battery 1, or decrease of the capacity of the sub-battery 2

In this state, SW3 is OFF, SW2 is ON, and the lead battery 1 is charged. Also SW2 is OFF, SW1 and SW2 are ON, and the sub-battery 2 is charged. Further SW1, SW2, and SW3 are ON, the lead battery 1 and the sub-battery 2 are charged.

(7) A state of occurring of the voltage difference between the lead battery 1 and the sub-battery 2

In this state, SW1, SW2, and SW3 are ON, the voltages of the lead battery 1 and the sub-battery 2 are equalized.

(8) When the sub-battery 2 is charged to the maximum remaining capacity while being charged, or the sub-battery 2 is discharged to the minimum remaining capacity while being discharged, the control circuit 15 detects those, it turns SW1 OFF, it prevents over charge or over discharge.

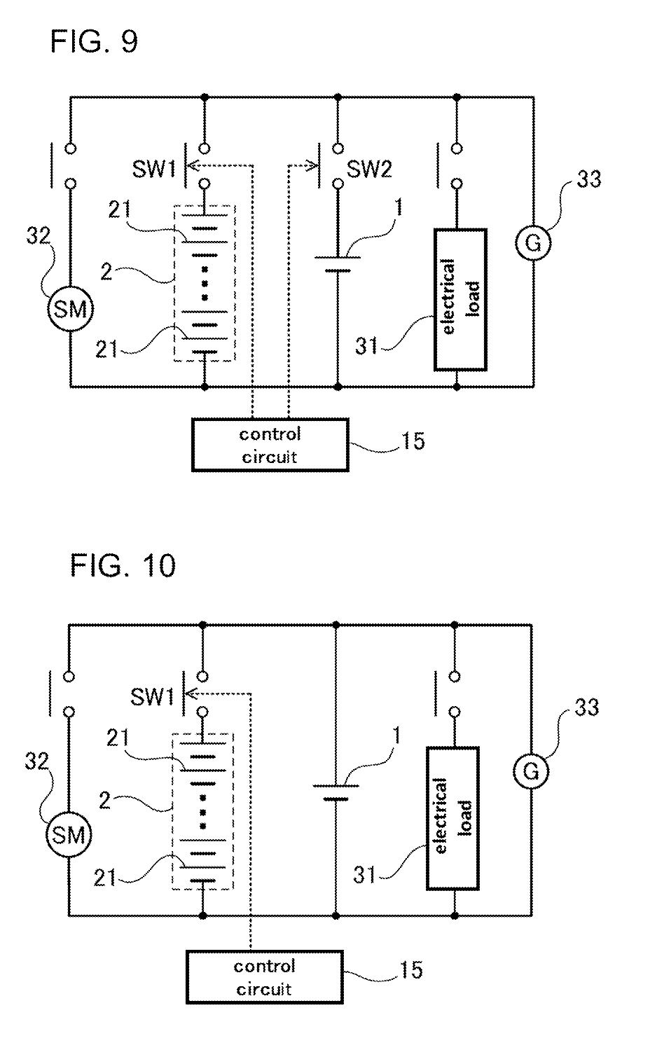

In the battery for automotive electrical system of FIG. 9, the first output switch SW1 is connected to the output side of the sub-battery 2, the second output switch SW2 is connected to the output side of the lead battery 1, the control circuit 15 carries out ON/OFF control of the switches SW1, SW2. This battery for automotive electrical system turns the switches SW1, SW2, SW3 ON/OFF by the control circuit 15 in the following way.

(1) A state of discharging to an electrical load 31 by a low rate current

In this state, SW1 is OFF, SW2 is ON, and power is supplied to the electrical load 31 from the lead battery 1.

In this state, SW1 and SW2 are ON, and power can be supplied to the electrical load 31 from both the lead battery 1 and the sub-battery 2.
(2) A state of discharging to an electrical load 31 by a high rate current

In this state, SW1, SW2 are ON, and power is supplied to the electrical load 31 from both the lead battery 1 and the sub-battery 2.

(3) A state of momentarily discharging by a high rate current at the time of starting an engine by a starter motor 32

In this state, SW2 are OFF, SW1 is ON, and power is supplied to the starter motor 32 from the sub-battery 2.

In this state, SW1 and SW2 are ON, and power can be supplied to the starter motor 32 from both the lead battery 1 and the sub-battery 2. In addition, SW1 is OFF, SW2 is ON, and power is supplied to the starter motor 32 only from the lead battery 1.

(4) A state of starting the starter motor 32 while power is supplied to the electrical load 31

In this state, SW1 and SW2 are ON, and power is supplied to the starter motor 32 and the electrical load 31 from the sub-battery 2 and the lead battery 1.

(5) A state of charging by regenerative energy from regenerative braking

In this state, SW1 is ON, and the sub-battery 2 is charged by regenerative energy.

In this state, SW1 and SW2 are ON, and both the lead battery 1 and the sub-battery 2 are charged by regenerative energy. Especially, when the remaining capacity of the sub-battery 2 increases near the maximum remaining capacity, both the lead battery 1 and the sub-battery 2 are charged by regenerative energy, it prevents over charge of the sub-battery 2. Further, when the remaining capacity of the sub-battery 2 reaches the maximum remaining capacity, SW1 is turned OFF, only the lead battery 1 is charged by regenerative energy.

(6) A state of charging by a low rate current at the time of decrease of the capacity of the lead battery 1, or decrease of the capacity of the sub-battery 2

In this state, SW1 is OFF, SW2 is ON, and the lead battery 1 is charged. Also SW2 is OFF, SW1 is ON, and the sub-battery 2 is charged. Further SW1 and SW2 are ON, the lead battery 1 and the sub-battery 2 are charged.

(7) A state of occurring of the voltage difference between the lead battery 1 and the sub-battery 2

In this state, SW1 and SW2 are ON, the voltages of the lead battery 1 and the sub-battery 2 are equalized.

(8) When the sub-battery 2 is charged to the maximum remaining capacity while being charged, or the sub-battery 2 is discharged to the minimum remaining capacity while being discharged, the control circuit 15 detects those, it turns SW1 OFF, it prevents over charge or over discharge.

In the battery for automotive electrical system of FIG. 10, the first output switch SW1 is connected to only the output side of the sub-battery 2, the control circuit 15 carries out ON/OFF control of the switches SW1.

(1) A state of discharging to an electrical load 31 by a low rate current

In this state, SW1 is OFF, and power is supplied to the electrical load 31 only from the lead battery 1.

In this state, SW1 is ON, and power can be supplied to the electrical load 31 from both the lead battery 1 and the sub-battery 2.

(2) A state of discharging to an electrical load 31 by a high rate current

In this state, SW1 is ON, and power is supplied to the electrical load 31 from both the lead battery 1 and the sub-battery 2.

(3) A state of momentarily discharging by a high rate current at the time of starting an engine by a starter motor 32

In this state, SW1 is ON, and power is supplied to the starter motor 32 from the sub-battery 2 and the lead battery 1.

(4) A state of starting the starter motor 32 while power is supplied to the electrical load 31

In this state, SW1 is ON, and power is supplied to the starter motor 32 and the electrical load 31 from the sub-battery 2 and the lead battery 1.

(5) A state of charging by regenerative energy from regenerative braking

In this state, SW1 is ON, and the sub-battery 2 and the lead battery 1 are charged by regenerative energy.

When the remaining capacity of the sub-battery 2 reaches the maximum remaining capacity, SW1 is turned OFF, only the lead battery 1 is charged by regenerative energy.

(6) A state of charging by a low rate current at the time of decrease of the capacity of the lead battery 1, or decrease of the capacity of the sub-battery 2

In this state, SW1 is OFF, and the lead battery 1 is charged. Also SW1 is ON, the lead battery 1 and the sub-battery 2 are charged.

(7) A state of occurring of the voltage difference between the lead battery 1 and the sub-battery 2

In this state, SW1 is ON, the voltages of the lead battery 1 and the sub-battery 2 are equalized

(8) When the sub-battery 2 is charged to the maximum remaining capacity while being charged, or the sub-battery 2 is discharged to the minimum remaining capacity while being discharged, the control circuit 15 detects those, it turns SW1 OFF, it prevents over charge or over discharge.

The battery for automotive electrical system shown in the electrical circuit of FIG. 8 to FIG. 10 is charged by a generator 33 at the vehicle side. The generator 33 at the vehicle side controls an output voltage such that a charging voltage does not exceed the maximum voltage (for example, 14 V to 15 V) in a state of charging the battery for automotive electrical system, it prevents the over charge of the battery for automotive electrical system. Here, even in this state, the remaining capacity of the sub-battery 2 is detected by the control circuit 15. And when the remaining capacity is beyond the maximum remaining capacity in the charging state, the control circuit 15 turns the output switch SW1 OFF, and then it prevents the over charge of the sub-battery 2.

Further the battery for automotive electrical system shown in FIG. 8 to FIG. 10 is discharged to supply power to the electrical load 31 or the starter motor 32. The vehicle side controls the generator 33, and charge the battery for automotive electrical system such that the voltage of the battery for automotive electrical system does not decrease equal to or less than the optimum voltage.

In a state of discharging from the battery for automotive electrical system, the remaining capacity of the sub-battery 2 is detected by the control circuit 15. And when it is discharged in a state that the voltage of the remaining capacity is equal to or less than the minimum voltage, the control circuit 15 turns the output switch SW1 OFF, it prevents the over discharge of the sub-battery 2.

The output switches SW1, SW2, SW3 which the battery for automotive electrical system shown are relays or semiconductor switching elements. As the semiconductor switching element, a transistor, a FET, IGBT, or the like can be used. Those output switches are disposed in a storage portion provided within the outer case, and connected between the sub-terminal and the battery pack. The outer case has the storage portion at the upper portion thereof, and the output switches are disposed in this storage portion. Here, the output switches can also be connected between the sub-terminal and the main terminal.

### INDUSTRIAL APPLICABILITY

The battery for automotive electrical system of the present invention is installed in the vehicle which is driven by an engine or a motor for drive as a battery for automotive electrical system, and is suitably used as a battery for automotive electrical system which is effectively charged by regenerative energy from regenerative braking.

1. A battery for automotive electrical system comprising:
a lead battery having an outer shape of a rectangular box, and having the length (L) thereof which is longer than the width (W) thereof;
a sub-battery being connected in parallel to the lead battery; and
a first main terminal as a positive electrode terminal and a second main terminal as a negative electrode terminal being disposed at both ends adjacent to a long side on an upper surface of the rectangular box,
wherein the first main terminal as an output terminal is connected to a lead wire for a vehicle, and the second main terminal is connected to the sub-battery,
wherein the sub-battery has a structure in which plural cells are stored in an outer case, and the outer case is disposed outside an end portion in the lengthwise direction of the lead battery and adjacent to the second main terminal of the lead battery, and the lead battery and the sub-battery are coupled.

2. The battery for automotive electrical system according to claim 1, wherein in the sub-battery a second sub-terminal is connected to the second main terminal of the lead battery, and is disposed at an end to the second main terminal of the lead battery on an upper surface of the outer case.

3. The battery for automotive electrical system according to claim 2, wherein in the sub-battery a first sub-terminal and the second sub-terminal are disposed at both ends in the width direction on an upper surface of the outer case, and the second sub-terminal is connected to the second main terminal of the lead battery.

4. The battery for automotive electrical system according to claim 3, wherein the first main terminal of the lead battery and the first sub-terminal of the sub-battery are connected by a first bus bar disposed on an upper surface of the lead battery and an upper surface of the first bus bar is insulated.

5. The battery for automotive electrical system according to claim 1, wherein a width size (w) of the outer case of the sub-battery does not project from the width of the lead battery.

6. The battery for automotive electrical system according to claim 1, wherein a height size (h) of the outer case of the sub-battery does not project from the height of the lead battery.

7. The battery for automotive electrical system according to claim 1, wherein the width size (w) of the outer case of the sub-battery is approximately the same as the width size (W) of the lead battery.

8. The battery for automotive electrical system according to claim 1, wherein the height size (h) of the outer case of the sub-battery is approximately the same as the height size (H) of the lead battery.

9. The battery for automotive electrical system according to claim 1, wherein the sub-battery is any one of a nickel hydride battery, a nickel cadmium battery, or a non-aqueous electrolyte battery.

10. The battery for automotive electrical system according to claim 1, further comprising:
an output switch being connected in series to the sub-battery; and
a control circuit carrying out ON/OFF control of the output switch,
wherein the control circuit detects any one of a remaining capacity or a voltage of the sub-battery, and controls the output switch.

11. The battery for automotive electrical system according to claim 2, wherein the lead battery and the sub-battery are integrally connected by connecting part, and the main terminal of the lead battery and the sub-terminal of the sub-battery are connected by bus bar made of metal, and the metal bus bar is used as the connecting part.

12. The battery for automotive electrical system according to claim 11,
wherein the second main terminal of the lead battery and the second sub-terminal of the sub-battery are connected by the bus bar, and the bus bar is used as the connecting part.

13. The battery for automotive electrical system according to claim 11, wherein the first main terminal of the lead battery and the first sub-terminal of the sub-battery are connected by the bus bar, and the bus bar is used as the connecting part.
